(19) United States
(12) Patent Application Publication
(10) Pub. No.: US 2008/0062868 A1
(43) Pub. Date: Mar. 13, 2008

(54) Method and Apparatus for Managing Queues

(75) Inventors: Serag GadelRab, Kanata (CA); Sean Para, Stittsville (CA)

Correspondence Address: McGUINNESS & MANARAS LLP, 125 NAGOG PARK, ACTON, MA, 01720, US

(73) Assignee: Tundra Semiconductor

(21) Appl. No.: 11/850,900

(22) Filed: Sep. 6, 2007

Related U.S. Application Data
(60) Provisional application No. 60/824,880, filed on Sep. 7, 2006.

(51) Int. Cl. G08C 15/00

(52) U.S. Cl. 370/230

(57) ABSTRACT

There is provided a system and method of managing a multi-priority queue having a queue-fill reporter, a first predetermined queue-fill threshold for stopping the queue-fill reporter, a second and third predetermined queue-fill threshold for indicating that the queue-fill reporter can start reporting, and a first timer for allowing the queue-fill reporter to start reporting. Additional thresholds can be added for other priorities of traffic. A second clock can be linked to these additional thresholds. In one implementation only the second queue-fill threshold resets the timer and stars the reporter. In another implementation either the second queue-fill threshold or expiry of the timer can start the reporter and reset the timer.

### CROSS-REFERENCE TO RELATED APPLICATIONS

A claim of priority is made to U.S. Provisional Patent Application Ser. No. 60/824,880, entitled Method and Apparatus for Managing Queues, filed Sep. 7, 2006.

### FIELD OF THE INVENTION

The present invention relates to method and apparatus for managing queues and is particularly concerned with mitigating starvation of lower priority traffic.

### BACKGROUND OF THE INVENTION

Simulations of transactions between two peripheral component interconnect (PCI) blocks have shown that higher priority operations (writes) could starve lower priority operations (reads). This can be generalized to any network including a number of different buffers and a fabric or interconnect, feeding an egress buffer. A specific example of such a network is the input-buffered switch fabric (ISF).

Referring to FIG. 1a there is illustrated a known high/low priority queue. For the purposes of the present example assume a four-slot queue 10 having two priorities (High/Low). Two slots 12 are reserved for H or L priorities and two lots 14 are reserved for H priority packets only. The network 16 writes to the queue 10 and egress from the queue via an egress port 18.

Referring to FIG. 1b, when the egress port 18 is temporarily congested (no packets exit queue). The H or L slots 12 contain two L-priority packets 20 and 22 and the H-only slots 14 contain two H packets 24 and 26.

Referring to FIG. 1c, eventually egress flow resumes with sending highest priority packet 24 out of the queue. One H-priority packet 24 exits (labeled H1). The network 16 sees one H-priority slot available. The network 16 feeding egress port 18 reorders its ingress or intermediate queues and refills the available slot with a H-priority packet 28 (H3). Egress scheduling transmits packet 26 (H2) out causing the network to send in another H-priority packet (not shown in the figure). Transmission of H-priority packets can continue for a long duration while L-packets are starved.

Starvation happens because, in the present example, the egress arbitration scheme always chooses to send a High priority packet to fill an available slot in the queue 10.

Starvation depends on the protocol.

SRIO
If Receiver-based flow control, congestion causes retries. Retries cause egress queue re-ordering forcing transmission of high-priority packets.
If Transmitter-based flow control. Lack of available buffer at receiver will force re-ordering of transmitter egress queue. Because lack of retry, Transmitter based flow control will cause fewer re-ordering events, thus reducing the probability of starvation.

PCI to PCI Block communication
Current PCI block mapping: Posted operations=priority 2 (Highest) Responses=priority 1 Read Requests=priority 0 (Lowest)
When Highest priority buffers are filled, Egress arbitration selects posted packets to comply with PCI-SIG specifications
This causes starvation of responses and read requests

Referring to FIG. 2a there is illustrated a known apparatus for managing the queue of FIG. 1. A thermometer circuit is added to the queue to prevent starvation. The thermometer circuit uses a stop report threshold 30 and a resume report threshold 32, while a watermark 34 indicates a boundary between the H only slots 14 and the H or L slots 12, as in FIG. 1.

In operation, when the queue fill-level reaches the STOP_REPORT threshold 30. The queue 10 stops reporting any newly available slots to network 16, even if H-priority packets have exited egress port 18. The RESUME_REPORT threshold 32 is positioned within “H or L” region 12 of queue 10. As packets drain out of egress port 18, fill-level of queue 10 decreases. Once fill-level reaches the RESUME_REPORT threshold 32, the queue 10 reports all empty queue slots to the network 16. Since the fill-level is within the “H or L” region, the network 16 does not re-order ingress queues. If L packet is head of line (HOL) in an ingress/intermediate queue, it is allowed to progress to the egress queue 10, consequently no starvation of L priority packets occurs. However, use of a thermometer circuit can result in a deadlock condition in normal operation.

Referring to FIG. 2b there is illustrated the apparatus of FIG. 2a in a filled condition. The H or L slots 12 contain two L-priority packets 20 and 22 and the H-only slots 14 contain two H packets 24 and 26. Assume the egress port 18 is temporarily blocked causing an accumulation of packets L1, L2, H1 and H2. This condition triggers the STOP_REPORT threshold 30. Any egress of packets is not reported to network 16 until a fill level is at or below the RESUME_REPORT threshold 32.

In operation, by way of example, the following happens:
H1 leaves the queue 10 but egress not reported to network 16. ISF thinks that the egress queue is full and does not replenish it.
H2 leaves queue 10 but egress is not reported to ISF 16. ISF thinks that the egress queue is full and does not replenish it. The queue may now be deadlocked, because L2 or L1 must egress before ISF 16 can send another packet (of H or L priorities). If the link-partner connected to the egress port 18 has no L-priority buffers to receive L2 or L1, the link is deadlocked.

The above illustrated scenario is a classic deadlock behavior that is explicitly called out in the SRIO and the PCI specifications:
RapidIO Part 6: 1x/4x LP-Serial Physical Layer Specification Rev. 1.3 Page 92 Rule #7 & following discussion.
PCI-2.3 Spec:Appendix E, Page 294-285 Rules #5, #6

Although the examples refer to buffers for shared buses, the same logic applies to buffers in switched topologies. For example one may think of PCI Delayed Requests as L-priority packets and Posted Writes as H-priority packets.

### SUMMARY OF THE INVENTION

An object of the present invention is to provide an improved method and apparatus for managing queues.

According to an aspect of the present invention there is provided an apparatus for managing a queue comprising a queue-fill reporter having a report state and a stop state, a first predetermined queue-fill threshold for causing the queue-fill reporter to enter the stop state, a second predetermined queue-fill threshold for causing the queue-fill reporter to enter the report state and a timer for causing, on expiry of a predetermined time period, the queue-fill reporter to enter the report state.

According to another aspect of the present invention there is provided an apparatus for managing a multi-priority queue comprising a queue-fill reporter, a first predetermined queue-fill threshold for stopping the queue-fill reporter, a second and third predetermined queue-fill threshold for indicating that the queue-fill reporter can start reporting; and a first timer for allowing the queue-fill reporter to start reporting.

According to a further aspect of the present invention there is provided a method of managing a queue comprising reporting queue-fill, stopping the queue-fill reporting on reaching a first predetermined queue-fill threshold and timing for a predetermined time period, restarting queue-fill reporting either on reaching a second predetermined queue-fill threshold or on expiry of the predetermined time period.

According to another aspect of the present invention there is provided a method of managing a multi-priority queue comprising reporting queue-fill, stopping the queue-fill reporting on reaching a first predetermined queue-fill threshold and timing for a predetermined time period and restarting queue-fill reporting either on reaching a second predetermined queue-fill threshold, a third predetermined queue-fill threshold or on expiry of the predetermined time period.

### BRIEF DESCRIPTION OF THE DRAWINGS

The present invention will be further understood from the following detailed description with reference to the drawings in which:

FIGS. 1a, 1b, and 1c illustrate a known queue;

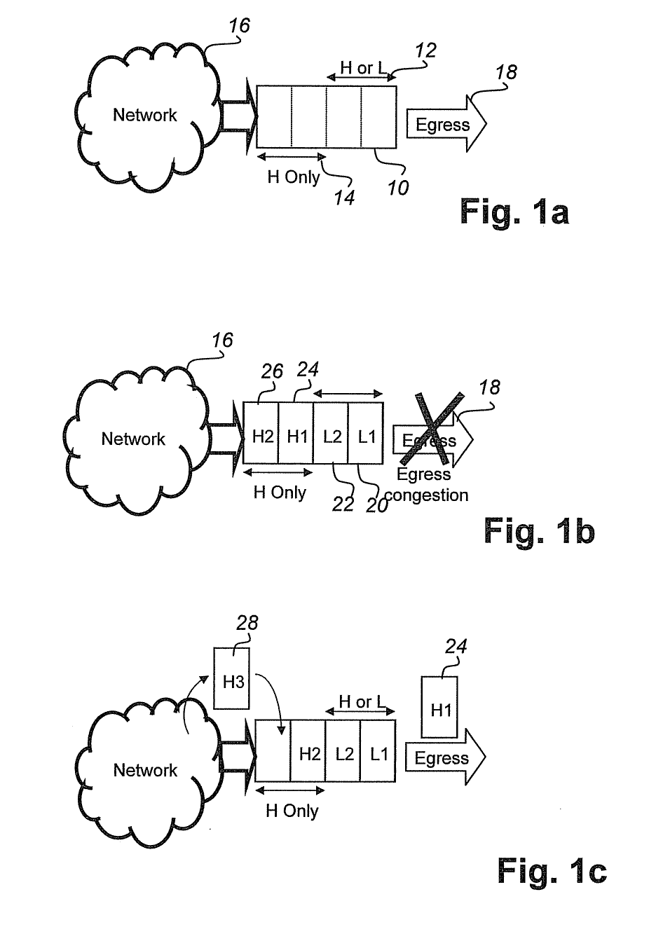

FIGS. 2a and 2b illustrate a known apparatus for managing the queue of FIGS. 1a, 1b, and 1c; and

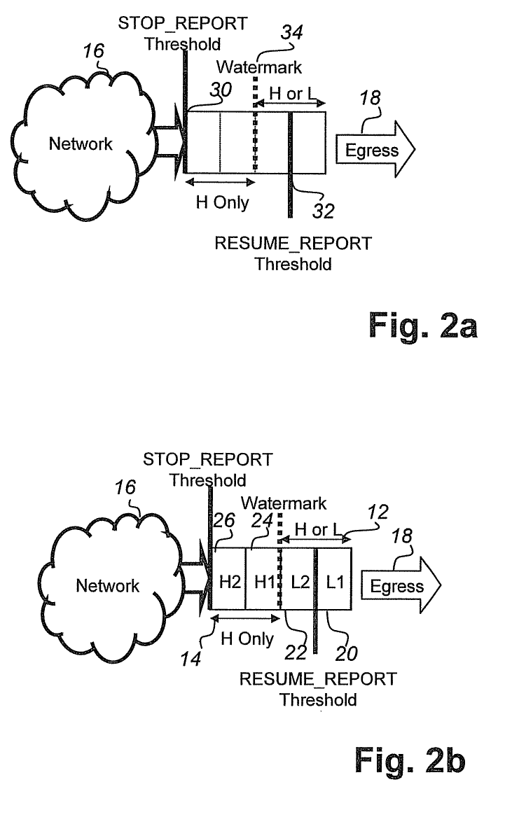

FIG. 3 illustrates in an apparatus for managing queues in accordance with an embodiment of the present invention;

FIG. 4 illustrates a state diagram for the apparatus of FIG. 3;

FIG. 5 illustrates a queue with a multi-priority thermometer circuit in accordance with an embodiment of the present invention;

FIG. 6 illustrates a state diagram for recovery from a stop report state for the queue of FIG. 5 in accordance with another embodiment of the present invention;

FIG. 7 illustrates a state diagram for recovery from a stop report state for the queue of FIG. 5 in accordance with a further embodiment of the present invention; and

FIG. 8 illustrates a queue with a multi-priority thermometer circuit in accordance with another embodiment of the present invention

### DETAILED DESCRIPTION OF THE PREFERRED EMBODIMENT

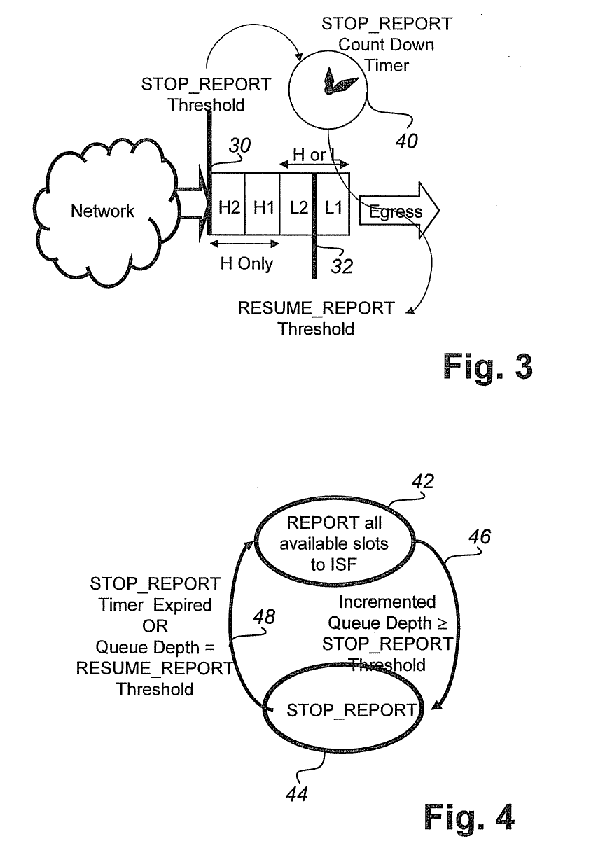

Referring to FIG. 3 there is illustrated an apparatus for managing queues in accordance with an embodiment of the present invention. The apparatus of FIG. 3 includes a STOP_REPORT count down timer 40.

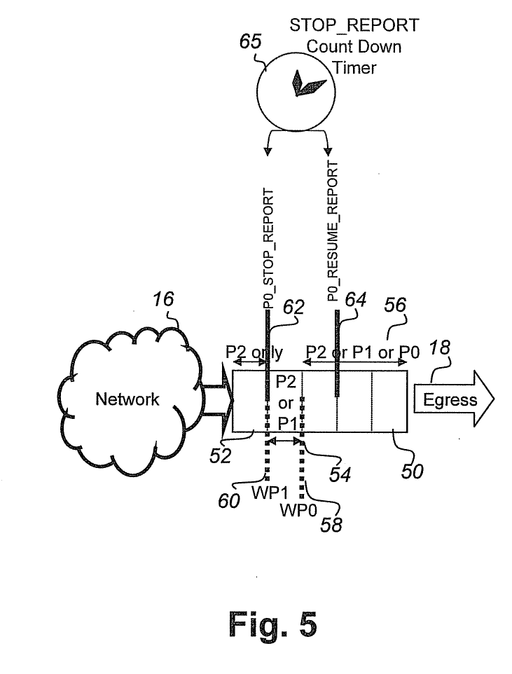

Referring to FIG. 4 there is illustrated a state diagram for the apparatus of FIG. 3. The apparatus has two states a report all available slots state 42 and a stop report state 44.

In operation, once the STOP_REPORT threshold 30 is reached 46 the queue 10 enters STOP_REPORT state 44 and does not report empty queue slots to network 16. Once STOP_REPORT state 44 is entered, the count down timer 40 is loaded and starts counting down. Once the count down timer 40 reaches zero 48, the queue 10 exits the STOP_REPORT state 44 even if RESUME_REPORT threshold 32 has not been achieved. Once the queue 10 exits the STOP_REPORT state 44, it reports all empty queue slots to network 16. If deadlock had occurred, the STOP_REPORT count down timer 40 allows the queue 10 to exit the deadlock state by exiting the STOP_REPORT state 44.

Choosing a duration of STOP_REPORT count down timer is system dependent, but the following should be considered. If the duration is too short, then the queue 10 does not have a chance to reach the Resume_REPORT threshold 32, consequently starvation may occur. If the duration is too long, then performance of the system may degrade. A suggested timer length is equal to time required to transmit the number of packets between the STOP_REPORT threshold 30 and the RESUME_REPORT threshold 32, assuming that these are maximum length packets. Preferably the timer duration is programmable. A maximum timer value is in the same order as time required to clear the entire queue.

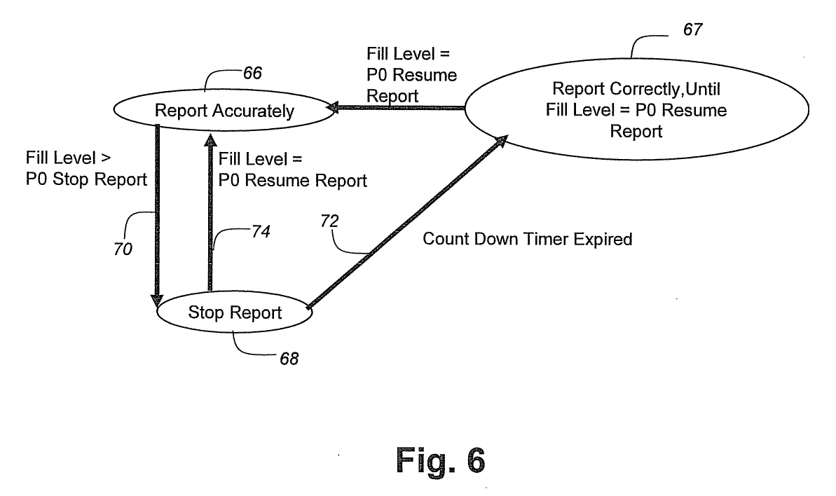

Referring to FIG. 5, there is illustrated a queue with a multi-priority thermometer. The queue 50 includes three priorities: P2 (highest), P1 (middle) and P0 (lowest). The queue is divided into P2 only 52, P1 or P2 region 54 and an any priority region 56. Watermarks 58 and 60 (WP1 and WP0) respectively mark last buffer available to P1 and P0. No watermark is required for P2.

In operation, the queue 50 enters the STOP_REPORT state 44 when the P0_STOP_REPORT threshold 62 for the lowest priority is reached. In this case, a P0_STOP_REPORT 62 is the lowest priority threshold. The queue exits the STOP_REPORT state 44, if: Buffer fill drops to P0_Resume_Report threshold 64 OR the count-down timer 65 expires. Note regarding relationship between WP and thermometer threshold:
STOP_REPORT=WP+1
RESUME_REPORT=WP−1.

Since there is only one STOP threshold 62 and one RESUME threshold 64, there is only need for one timer. The P0 timer 65 protects the entire queue from deadlock.

Choosing a value of RESUME_REPORT. The thermometer circuit frees the buffers back to two possible sources: network or preceding FIFO

Freeing buffers to network:
Only ONE “buffer available” can be signaled back to network per clock cycle.
network takes two cycles to schedule next packet (three cycles if re-ordering is required).
If RESUME_REPORT=WP−1 is used, then the network of preceding queues may see only one or two buffers being released when it is scheduling.
This would force network to send in a High priority packet which would then again block transmission of any low-priority packets.
So, in this case, use must set RESUME_REPORT to the lowest number possible without causing a gap in the output

Freeing buffers to preceding Queue
All buffers should be freed in a single clock cycle
Can set RESUME_REPORT=WP−1 with no fear of starvation.

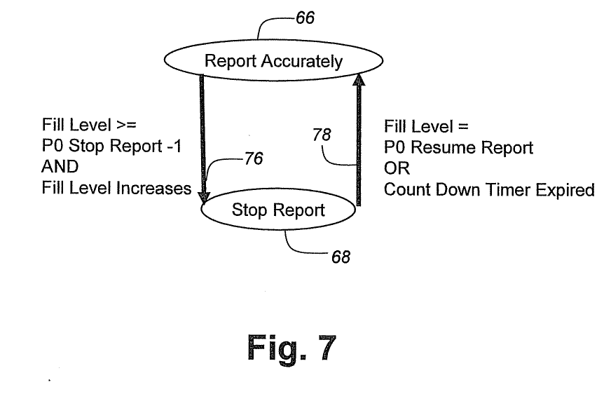

Referring to FIG. 6, there is illustrated a state diagram for recovery from a stop report state for the queue of FIG. 5 in accordance with another embodiment of the present invention. The state diagram of FIG. 6 has three states REPORT ACCURATELY 66, REPORT ACCURATELY UNTIL fill level=P0 Resume Report 67 and STOP REPORT 68. The queue enters 70 the STOP_REPORT state 68 and activates count-down timer 65 when:
currently in REPORT state 66, AND
buffer_fill=(P0_STOP_REPORT−1) and push (with no pop on same clk)

The queue 50 exits STOP_REPORT state 68 and clears count-down timer 65 when: timer expires 72 OR buffer_fill=RESUME_REPORT threshold 74. If the count-down timer 65 expires prior to reaching P0_RESUME_REPORT 64 then enter state 67 and do not reactivate thermometer again until you have reached P0_RESUME_REPORT 64.

The thermometer circuit is meant to avoid, but not prevent starvation. If the count-down timer 65 expires and the queue 50 has not reached P0_RESUME_REPORT threshold 64, then the down-stream link must be congested. We do not want to re-arm the thermometer state machine under congestion conditions because we want to continue sending the high priority traffic. Re-arming the state-machine slows that traffic down due to the timer. Sending the high priority traffic should clear up outstanding operations at the endpoints. Clearing these outstanding operations allows low-priority traffic to flow again.

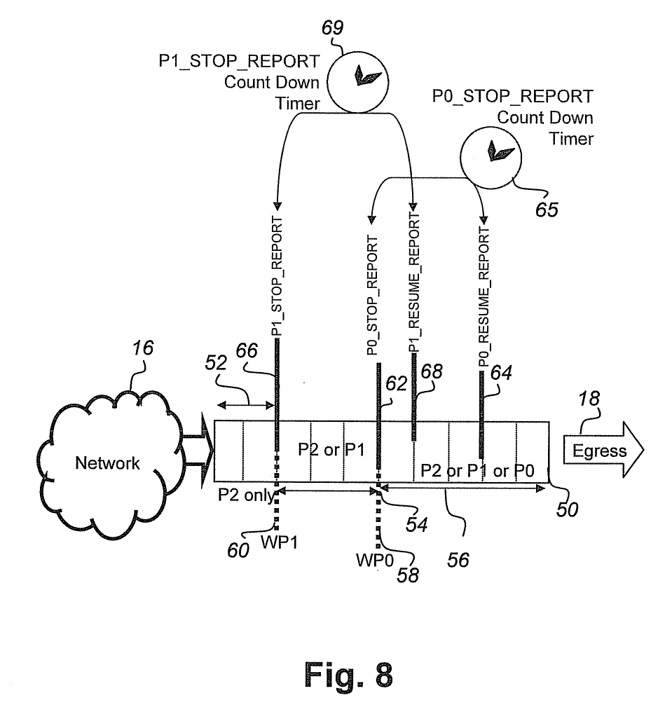

Referring to FIG. 7, there is illustrated a state diagram for recovery from a stop report state for the queue of FIG. 5 in accordance with a further embodiment of the present invention. The queue 50 enters 76 STOP_REPORT state 68 and activates the count-down timer 65 when:
Currently in REPORT state 66 & buffer_fill>=(P0_STOP_REPORT−1) & push (with no pop on same clk)

The queue 50 exits 78 STOP_REPORT state 68 and clears count-down timer when: timer expires 76 OR buffer_fill=P0_RESUME_REPORT 78. This means that if the count-down timer 65 expires prior to reaching P0_RESUME_REPORT the thermometer re-activates again (including Count-down timer) when a packet insertion into the queue causes the fill level to increase.

If we do not re-arm the thermometer circuit then we risk starving P0 (and maybe P1) when there is congestion in the down-stream devices that prevent forward progress.

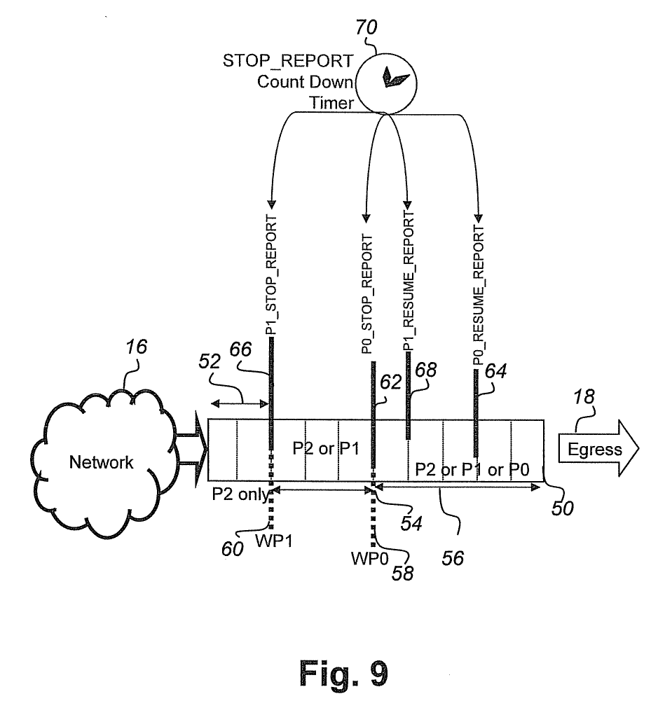

Referring to FIG. 8, there is illustrated a queue with a multi-priority thermometer. The queue 50 includes three priorities: P2 (highest), P1 (middle) and P0 (lowest). The queue is divided into P2 only 52, P1 or P2 region 54 and an any priority region 56. Watermarks 58 and 60 (WP1 and WP0) respectively mark last buffer available to P1 and P0. No watermark is required for P2. In addition to the P0 thresholds of FIG. 5, FIG. 8 includes P1 thresholds, P1_STOP_REPORT 66 and P1_RESUME_REPORT 68 and P1_RESUME_REPORT countdown timer 69.

In operation, multiple thresholds allow P1 and P2 traffic to progress while starving P0 traffic. Multiple thresholds also ensure P0 and P1 traffic progresses in the absence of P2 traffic. This is achieved by setting the P0_STOP_REPORT threshold at a higher queue fill that the P1_STOP_REPORT. By letting P0 traffic through after the P0_RESUME_REPORT has been reached and until the P1_RESUME_REPORT has been reached and both timers reset.

Having a P1_STOP_REPORT may seem redundant because to reach that threshold, one needs to have crossed the P0_STOP_REPORT threshold. However, one may wish to have multiple stop states corresponding to traffic priority. Having a P1_RESUME_REPORT protects P1 from starvation by P2, but may allow P1 and P2 to starve P0.

Referring to FIG. 9, there is illustrated a queue with a multi-priority thermometer. The queue 50 includes three priorities: P2 (highest), P1 (middle) and P0 (lowest). The queue is divided into P2 only 52, P1 or P2 region 54 and an any priority region 56. Watermarks 58 and 60 (WP1 and WP0) respectively mark last buffer available to P1 and P0. No watermark is required for P2. FIG. 9 includes P1 thresholds, P1_STOP_REPORT 66 and P1_RESUME_REPORT 68 and a single RESUME REPORT countdown timer 70. Operation is similar to that of FIG. 8 except that the stop report thresholds share one countdown timer 70, which is activated by either stop report threshold.

Numerous modifications, variations and adaptations may be made to the particular embodiments described above without departing from the scope patent disclosure, which is defined in the claims.

What is claimed is:

1. Apparatus for managing a queue comprising:
a queue-fill reporter having a report state and a stop state;
a first predetermined queue-fill threshold for causing the queue-fill reporter to enter the stop state;
a second predetermined queue-fill threshold for causing the queue-fill reporter to enter the report state; and
a timer for causing, on expiry of a predetermined time period, the queue-fill reporter to enter the report state.

2. The apparatus of claim 1, wherein the second queue-fill threshold can effect reset of the timer.

3. The apparatus of claim 2, wherein expiry of the predetermined time period can effect reset of the timer.

4. The apparatus of claim 1 wherein the queue has a plurality of priorities.

5. The apparatus of claim 4, wherein the second queue-fill threshold can effect reset of the timer.

6. The apparatus of claim 5, wherein expiry of the predetermined time period can effect reset of the timer.

7. Apparatus for managing a multi-priority queue comprising:
a queue-fill reporter;
a first predetermined queue-fill threshold for stopping the queue-fill reporter;
second and third predetermined queue-fill thresholds for indicating that the queue-fill reporter can start reporting; and
a first timer for allowing the queue-fill reporter to start reporting.

8. The apparatus of claim 7, wherein one of the second and third queue-fill threshold can effect reset of the timer.

9. The apparatus of claim 8, wherein expiry of the predetermined time period can effect reset of the first timer.

10. The apparatus of claim 7, further comprising a fourth threshold for stopping the reporter.

11. The apparatus of claim 10 wherein one of the second and third queue-fill threshold can effect reset of the first timer.

12. The apparatus of claim 11, wherein expiry of the predetermined time period can effect reset of the first timer.

13. The apparatus of claim 10, further comprising a second timer for allowing the queue-fill reporter to start reporting

14. The apparatus of claim 13 wherein one of the second and third queue-fill threshold can effect reset of the first and second timer, respectively.

15. The apparatus of claim 14, wherein expiry of the predetermined time period can effect reset of the respective one of the first and second timer.

16. A method of managing a queue comprising:
reporting queue-fill;
stopping the queue-fill reporting on reaching a first predetermined queue-fill threshold and timing for a predetermined time period; and
restarting queue-fill reporting either on reaching a second predetermined queue-fill threshold or on expiry of the predetermined time period.

17. The method of claim 16, wherein reaching the second queue-fill threshold also resets the predetermined time period.

18. The method of claim 17, wherein expiry of the predetermined time period also resets the predetermined time period.

19. The method of claim 16 wherein the queue has a plurality of priorities.

20. The method of claim 19, wherein reaching the second queue-fill threshold also resets the predetermined time period.

21. The method of claim 20, wherein expiry of the predetermined time period also resets the predetermined time period.

22. A method of managing a multi-priority queue comprising:
reporting queue-fill;
stopping the queue-fill reporting on reaching a first predetermined queue-fill threshold and timing for a predetermined time period; and
restarting queue-fill reporting either on reaching a second predetermined queue-fill threshold, a third predetermined queue-fill threshold or on expiry of the predetermined time period.

23. The method of claim 22, wherein reaching one of the second and third queue-fill thresholds also resets the predetermined time period.

24. The method of claim 23, wherein expiry of the predetermined time period also resets the predetermined time period.

25. The method of claim 22, further comprising a fourth threshold for stopping the reporter.

26. The method of claim 25 wherein reaching one of the second and third queue-fill threshold also resets the predetermined time period.

27. The method of claim 26, wherein expiry of the predetermined time period also resets the predetermined time period.

28. The method of claim 25, further comprising a second predetermined period of time for allowing the queue-fill reporter to start reporting

29. The method of claim 28 wherein reaching one of the second and third queue-fill threshold also resets the first and second predetermined time periods, respectively.

30. The method of claim 29, wherein expiry of the predetermined time period also resets a respective one of the first and second predetermined time periods.

31. Apparatus for managing a multi-priority queue comprising:
a queue having n levels of priority;
a queue-fill reporter;
n−1 queue-fill thresholds for stopping the queue-fill reporter, each stop report threshold associated with at least one level of priority;
n−1 predetermined queue-fill thresholds for indicating that the queue-fill reporter can start reporting (resume report); and
n−1 timers for allowing the queue-fill reporter to start reporting, each associated with at least one start report threshold;
where n is an integer greater than or equal to two;
whereby reporting for a priority resumes when the fill level is less than the resume report threshold for that priority and if the respective timer expires, then reporting for the priority occurs correctly until the fill level is less than the resume report threshold level.

32. Apparatus for managing a multi-priority queue comprising:
a queue having n levels of priority;
a queue-fill reporter;
n−1 queue-fill thresholds for stopping the queue-fill reporter, each stop report threshold associated with at least one level of priority;
n−1 predetermined queue-fill thresholds for indicating that the queue-fill reporter can start reporting (resume report); and
n−1 timers for allowing the queue-fill reporter to start reporting, each associated with at least one start report threshold;
where n is an integer greater than or equal to two;
whereby reporting for a priority resumes when the fill level is less than the resume report threshold for that priority, or if the count down timer associated with that priority expires, reporting stops for a priority whenever the queue fill level increases to be greater than or equal to the stop report threshold for that priority level.
